(19) United States
(12) Patent Application Publication
(10) Pub. No.: US 2025/0238700 A1
(43) Pub. Date: Jul. 24, 2025

(54) SYSTEM AND METHOD FOR SELECTING A QUANTUM HARDWARE FOR EXECUTING A QUANTUM CIRCUIT

(71) Applicant: LTI Mindtree Ltd, Mumbai (IN)

(72) Inventors: Saikat Basu, Mumbai (IN); Nayana Das, Mumbai (IN); Aniruddha Biswas, Mumbai (IN)

(21) Appl. No.: 19/027,960

(22) Filed: Jan. 17, 2025

(30) Foreign Application Priority Data
Jan. 19, 2024 (IN) 202421003728

(51) Int. Cl. G06N 10/20; G06N 10/70

(52) U.S. Cl. CPC G06N 10/20; G06N 10/70

(57) ABSTRACT

A system and method for selecting a quantum hardware from a plurality of quantum hardware for executing a quantum circuit is disclosed. The method and system decomposes a quantum circuit into a set of primitive gate operations corresponding to each quantum hardware. Thereafter, the method and system receives a noise profile associated with each quantum hardware of the plurality of quantum hardware. Subsequently, the method and system estimates a total execution time of quantum circuit on each quantum hardware, wherein the estimation is based on the set of primitive gate operations corresponding to the respective quantum hardware. Thereafter, the method and system computes a quantum success score for each quantum hardware based on the respective noise profile and the total execution time of each quantum hardware. Finally, a quantum hardware with the highest success score is selected as the most appropriate quantum hardware for the quantum circuit.

### FIELD

This disclosure generally relates to quantum computation and more specifically to a system and method for selecting a quantum hardware for executing a quantum circuit.

### BACKGROUND

Quantum computing stands at the forefront of technological advancement, promising superior capabilities that overcome the limitations of classical computing. It has the potential to redefine problem-solving, accelerate scientific discoveries, fortify security measures, and revolutionize sectors like finance, machine learning, and supply chain management.

Within service industries, the selection of quantum hardware for tailored solutions is important. Quantum hardware providers offer an array of quantum hardware options, each entailing varied costs and distinct performance characteristics. The criticality of choosing the right hardware tailored to specific tasks is significant in an environment where efficiency and precision is the most important requirement.

Traditionally, executing quantum algorithms through quantum circuits relied on a rudimentary approach-selecting available quantum hardware on an ad hoc basis. However, this method presents significant limitations. Diverse quantum hardware platforms exhibit unique performance characteristics, posing a challenge in making informed decisions that maximize efficiency and accuracy. The consequence of inappropriate hardware selection often translates to suboptimal performance, leading to inefficiencies and compromises in achieving desired outcomes.

Existing solutions attempts to compare performance parameters of quantum computers against specific execution tasks. These solutions consider factors like qubit count, gate types, and cycles, emphasizing metrics such as Quantum Volume or layout-specific errors. These methods, though insightful, fall short in addressing the complexities inherent in assessing hardware for specific quantum circuit executions. The gap between theoretical benchmarks and practical applicability undermines their effectiveness in guiding precise hardware selection for real-world applications.

There are solutions that look into optimizing quantum program execution and compiling quantum circuits on processors but lack efficient strategies for selecting specific quantum hardware for diverse quantum circuits.

Similarly, there are solutions that provide scheduling techniques to enhance quantum circuit execution but tend to focus on layout-specific errors and metrics, potentially limiting comprehensive hardware suitability assessments.

There is therefore a need for a method and system that enables selection of suitable quantum hardware tailored for specific quantum circuits, without necessitating additional quantum resources, for enhancing the overall quantum circuit performance.

Limitations and disadvantages of conventional and traditional approaches will become apparent to one of ordinary skill in the art, through comparison of described systems with some aspects of the present disclosure, as set forth in the remainder of the present application and with reference to the drawings.

### SUMMARY

A system and method is disclosed for selecting a quantum hardware for executing a quantum circuit, as shown in and/or described in connection with, at least one of the figures.

In an example implementation, a system for selecting a quantum hardware from a plurality of quantum hardware for executing a quantum circuit is disclosed. The system includes a decomposing model for decomposing the quantum circuit into a set of primitive gate operations corresponding to each quantum hardware. The system also includes a parameter fetching module for receiving a noise profile corresponding to each quantum hardware of the plurality of quantum hardware. The system further includes a time estimator module for estimating a total execution time of quantum circuit on each quantum hardware. A execution time on a quantum hardware is estimated based on a set of primitive gate operations corresponding to the quantum hardware. The system further includes a success score computing module for computing a quantum success score of each quantum hardware based on the corresponding noise profile and the total execution time of each quantum hardware. The system also includes a hardware selection module for selecting a quantum hardware with a highest quantum success score for executing the quantum circuit.

In an aspect combinable with the example implementation, a noise profile of a quantum hardware includes one of a qubit quality, qubit properties, a hardware specific relaxation time, a coherence time, error rates corresponding to the primitive gate operations.

In another aspect combinable with any of the previous aspects, the parameters of the quantum circuit includes the properties of the quantum circuit, a gate count, gate types, a circuit depth, and other characteristics relevant to quantum computation.

In another aspect combinable with any of the previous aspects, the success score computing module takes into consideration error probability of the quantum circuit due to amplitude damping, phase damping, errors due to noisy gate errors, and errors due to state preparation and measurement for computing the success score.

In another example implementation, a method for selecting a quantum hardware from a plurality of quantum hardware for executing a quantum circuit is disclosed. The method includes decomposing, for each quantum hardware of the plurality of quantum hardware, the quantum circuit into a set of primitive gate operations corresponding to each quantum hardware. The method receives a noise profile associated with each quantum hardware of the plurality of quantum hardware. The method estimates an execution time of quantum circuit on each quantum hardware. The estimation is based on the set of primitive gate operations corresponding to the respective quantum hardware. Further, the method computes a quantum success score for each quantum hardware based on the respective noise profile and the total execution time of each quantum hardware. Further, the method selects a quantum hardware with a highest quantum success score for executing the quantum circuit.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram of a distributed quantum computing system in which systems and/or methods described herein may be implemented in accordance with an exemplary embodiment of the disclosure.

FIG. 2 is a block diagram depicting various components of a quantum hardware selector in accordance with an exemplary implementation of the disclosure.

FIG. 3 illustrates a flowchart of a method for selecting a quantum hardware from a plurality of quantum hardware for executing a quantum circuit in accordance with an exemplary implementation of the disclosure.

### DETAILED DESCRIPTION

The following described implementations may be found in the disclosed system and method for selecting a quantum hardware from a plurality of quantum hardware for executing a quantum circuit.

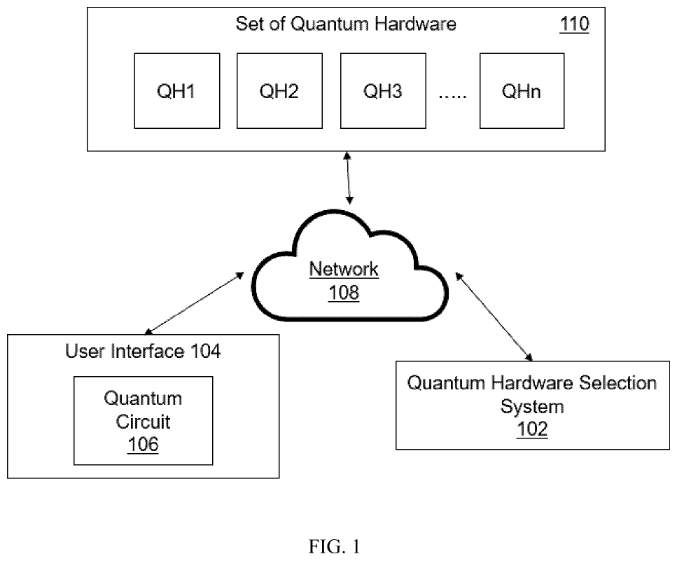

FIG. 1 is a block diagram of a distributed quantum computing system in which systems and/or methods described herein may be implemented in accordance with an exemplary embodiment of the disclosure. Referring to FIG. 1, there is shown a quantum hardware selector 102, a user interface 104, a quantum circuit 106, a network 108 and a set of quantum hardware 110.

The network 108 enables interconnections between the quantum hardware selector 102, the user interface 104 and the set of quantum hardware 110.

The network 106 includes communication networks operable to facilitate communications, either wirelessly or wired. Any of the communications networks may include, but not limited to, any one of a combination of different types of suitable communications networks such as, for example, broadcasting networks, cable networks, public networks (for example, the Internet), private networks, wireless networks, cellular networks, or any other suitable private and/or public networks. Further, any of the communications networks may have any suitable communication range associated therewith and may include, for example, global networks (for example, the Internet), metropolitan area networks (MANs), wide area networks (WANs), local area networks (LANs), or personal area networks (PANs). In addition, any of the communications networks may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

The interface 104 may be used by the end users of the system for interacting with the quantum hardware selector 102.

The quantum hardware selector 102 may comprise suitable logic, interfaces, and/or code that may be configured to receive the quantum circuit 104 as input for identifying the most suitable quantum hardware (H_1 to H_n) from the set of quantum hardware 108. In the context of selecting quantum hardware for a task, various technology options such as Superconducting, Ion trap, Photonics, Neutral atom, and more are available. For instance, when considering superconducting qubits, there is a diverse range of quantum hardware instances from different developers.

The above provided implementations present an approach to controlling for selecting a quantum hardware from a plurality of quantum hardware for executing a quantum circuit. Further modifications and alternative embodiments of various aspects will be apparent to those skilled in the art in view of this description.

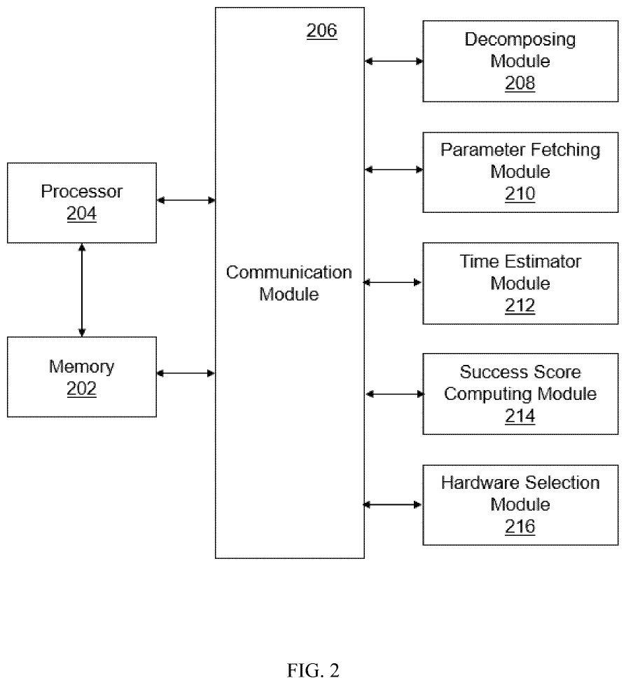

FIG. 2 is a block diagram depicting various components of a quantum hardware selector in accordance with an exemplary implementation of the disclosure. Referring to FIG. 2, there is shown a memory 202, a processor 204, a communication module 206, a decomposing module 208, a parameter fetching module 210, a time estimator module 212, a success score computing module 214, and hardware selection module 216.

The memory 202 may comprise suitable logic, and/or interfaces, that may be configured to store instructions (for example, computer readable program code) that can implement various aspects of the present disclosure.

The processor 204 may comprise suitable logic, interfaces, and/or code that may be configured to execute the instructions stored in the memory 202 to implement various functionalities of the quantum hardware selector 102 in accordance with various aspects of the present disclosure. The processor 204 may be further configured to communicate with various modules of the quantum hardware selector 102 via the communication module 206.

The communication module 206 may comprise suitable logic, interfaces, and/or code that may be configured to transmit data between modules, databases, memories, and other components of the quantum hardware selector 102 for use in performing the functions discussed herein. The communication module 206 may include one or more communication types and utilizes various communication methods for communication within the quantum hardware selector 102.

The quantum hardware selector 102 may comprise suitable logic, interfaces, and/or code that may be configured to interact with the user interface 104 for obtaining the quantum circuit 106 as an input. In the process of implementing a quantum algorithm for tasks such as optimization or machine learning, the initial step involves the creation of a program within quantum computing framework. These frameworks play a pivotal role by translating high-level programming instructions into a corresponding quantum circuit. This quantum circuit encapsulates the logic and operations of the intended quantum algorithm. Once the quantum circuit is defined, it serves as the blueprint for the quantum computation. Subsequently, the quantum circuit is executed on quantum hardware, facilitating the practical realization of the programmed quantum algorithm.

The quantum circuit 106 obtained by the quantum hardware selector 102 is passed on to the decomposing module 208.

The decomposing module 208 may comprise suitable logic, interfaces, and/or code that may be configured to decompose all the gate operations of the quantum circuit 106 into one or more primitive gate operations corresponding to each quantum hardware (H_1 to H_n) included in the set of quantum hardware 110.

In the landscape of quantum computing, each quantum hardware is equipped with a distinct set of primitive gate operations that can be directly executed. These operations form the foundation of quantum computation on the specific hardware. In cases where a quantum circuit incorporates a non-primitive gate, i.e., a quantum gate not directly implementable on the targeted quantum hardware, a step of decomposition is performed. Decomposing a quantum circuit involves breaking down non-primitive gates into a sequence of multiple primitive gate operations. This process ensures compatibility between the quantum circuit and the capabilities of the quantum hardware, allowing for the seamless execution of complex quantum algorithms by translating them into operations that the hardware can directly accommodate.

The decomposing module 208 may be configured to derive parameters corresponding to the quantum circuit 106 such as, but not limited to, a gate count, gate types, a circuit depth, and other characteristics relevant to quantum computation.

The parameter fetching module 210 may comprise suitable logic, interfaces, and/or code that may be configured to fetch one or more parameters corresponding to each quantum hardware (H_1 to H_n) included in the set of quantum hardware 110. The one or more parameters include relaxation time (T₁), coherence time (T₂), error rates corresponding to different primitive gates operations.

In the domain of quantum computing, each quantum state is characterized by its amplitude and phase information. However, these delicate quantum states are susceptible to degradation over time. The relaxation time (T₁) signifies the duration it takes for a quantum state to lose its amplitude, while the coherence time (T₂) represents the period over which the phase information dissipates. These temporal parameters play a crucial role in determining the stability and viability of quantum states within the computational framework.

Additionally, the implementation of quantum gate operations introduces an inherent element of noise. Consequently, all quantum gate operations exhibit an associated error rate. This error rate quantifies the likelihood of inaccuracies in the execution of primitive gate operations. Understanding and managing these factors-relaxation time, coherence time, and error rates—are essential considerations in optimizing the performance and reliability of quantum computations on quantum hardware.

In accordance with the invention, the parameters corresponding to the quantum hardware such as relaxation time (T₁), coherence time (T₂), error rates corresponding to different primitive gates operations provides a noise profile for each quantum hardware. Accordingly, the invention takes into consideration a noise profile of a quantum hardware for evaluating the suitability of the quantum hardware for a given quantum circuit.

While Quantum Volume and Algorithmic Qubits are useful benchmarks for certain aspects of quantum hardware, they have limitations that make them less suitable for assessing real-world quantum computers. It has been observed that a quantum computer with lower quantum volume may provide better accuracy for certain quantum circuits. This highlights some limitations of quantum volume metric, in identifying better performing quantum hardware.

The basic reasons behind these limitations include the neglecting noise models and hardware noise profiles, qubit quality, connectivity, and a lack of relevance to practical quantum applications. These oversimplification pushes the state-of-the-art methods far from reality. Therefore, it is prudent to consider these limitations when using these benchmarks and seek additional metrics or approaches to provide a more comprehensive evaluation of quantum hardware performance.

The time estimator module 212 may comprise suitable logic, interfaces, and/or code that may be configured to estimate total execution time (t) of each quantum hardware (H_1 to H_n) for performing the primitive gate operations of the decomposed quantum circuit (106).

In an embodiment, the time estimator module 212 may take into consideration the parameters corresponding to the quantum circuit 106 such as, but not limited to, a gate count, gate types, a circuit depth, and other characteristics relevant to quantum computation, for estimating total time executive time of each quantum hardware (H_1 to H_n).

The success score computing module 214 may comprise suitable logic, interfaces, and/or code that may be configured to estimate a success score (Qss) of the quantum circuit 106 on each quantum hardware (H_1 to H_n) of the set of quantum hardware (110).

In an embodiment of the invention, Qss is proportional to the worst-case success probability of the quantum circuit 106 on a specific quantum hardware.

In an exemplary implementation of the invention, Qss involves estimation of an error probability of the quantum circuit 106 due to, but not limited to, error probability of the quantum circuit due to amplitude damping, phase damping, errors due to noisy gate errors, and errors due to state preparation and measurement.

This may be represented as: Qₛₛ∝(Pₛ(c, nₕ)
Where,
   Pₛ is the success probability of a quantum circuit (c) on a quantum hardware (h).

As known, each qubit in quantum hardware behaves differently in the presence of noise. So, an efficient mapping of the quantum circuit 106 into a quantum hardware (H_1 to H_n) of the set of quantum hardware 110 is utmost important.

The parameters corresponding to the quantum hardware such as relaxation time (T₁), coherence time (T₂), error rates corresponding to different primitive gates operations provides a noise profile for each quantum hardware which is taken into account while estimating Qss for the quantum circuit 106 on each quantum hardware.

The parameters corresponding to the quantum circuit 106 such as, but not limited to, a gate count, gate types, a circuit depth, and other characteristics relevant to quantum computation, are taken into account by the success score computing module 214 for calculating Qss for the quantum circuit 106.

In an embodiment, a layout placement score (Lₕ) that provides a mapomatic score of each quantum hardware is also taken into account while calculating Qss.

Each quantum hardware is characterized by its unique layout, specifically the connectivity structure of qubits, coupled with individual qubit error rates. The quality of the qubits and their interconnection play a pivotal role in the accuracy of quantum computations. Introducing the concept of a layout placement score, this metric assesses the optimal mapping of a quantum circuit onto a given quantum hardware.

The layout placement score reflects the quality of the alignment between the quantum circuit and the hardware's qubit connectivity. A higher layout placement score indicates a superior mapping, considering both the connectivity structure and the inherent error rates of individual qubits. Therefore, an elevated layout placement score signifies an improved accuracy in the execution of quantum computations on the respective quantum hardware, emphasizing the importance of strategic mapping for enhanced performance.

Hence, considering the layout score, the Qss can be written as:

Qₛₛ=LₕPₛ(c,nₕ)
Where,
   Pₛ is the success probability of a quantum circuit (c) on a quantum hardware (h). Ps can be written as:

$${P}_{S} = {e}^{- τ ( \frac{1}{{T}_{1}} + \frac{1}{{T}_{2}} )} X {π}_{i = 0}^{k} ( 1 - {p}_{i} )$$

Here, Pᵢ is the worst-case error probability of i^{th} quantum gate.

The success score computing module 214 is configured to perform these calculations iteratively for the quantum circuit 106 corresponding to each quantum hardware of the set of quantum hardware 110.

Once the success score computing module 214 has calculated the Qss corresponding to each quantum hardware, the hardware selection module 216 that may comprise suitable logic, interfaces, and/or code is configured to select a quantum hardware (H_1 to H_n) having the highest Qss for the quantum circuit 106.

Further modifications and alternative embodiments of various aspects will be apparent to those skilled in the art in view of this description for handling any available quantum hardware or for quantum hardware that may become available as the industry progresses.

The proposed method and system for selecting an optimal quantum hardware disclosed herein, targets a broad audience of stakeholders in the quantum computing ecosystem who require a methodical and data-driven approach to quantum hardware selection for improved accuracy in their quantum computations.

Enterprises exploring the potential of quantum computing for various applications, such as optimization or machine learning etc. may use this solution to make informed decisions about which quantum hardware to invest in or utilize.

For quantum computing researchers, this method provides a structured and methodical approach to assess and select quantum hardware for experiments and studies. Its systematic framework promises to optimize hardware selection, ensuring reliability and accuracy in research outcomes across various disciplines.

Quantum hardware providers, at the forefront of quantum technology development, are poised to benefit from this solution. It serves as a valuable tool to demonstrate the performance and advantages of their quantum computing platforms, potentially influencing market adoption and establishing a competitive edge.

Universities and educational institutions offering quantum computing and quantum programming courses could benefit from this solution as part of their curriculum. Educating students on strategic hardware selection strategies.

Quantum Consultants, Advisors and Solution Architects advising clients on quantum computing adoption and strategy could use this solution to provide expert recommendations on hardware choices.

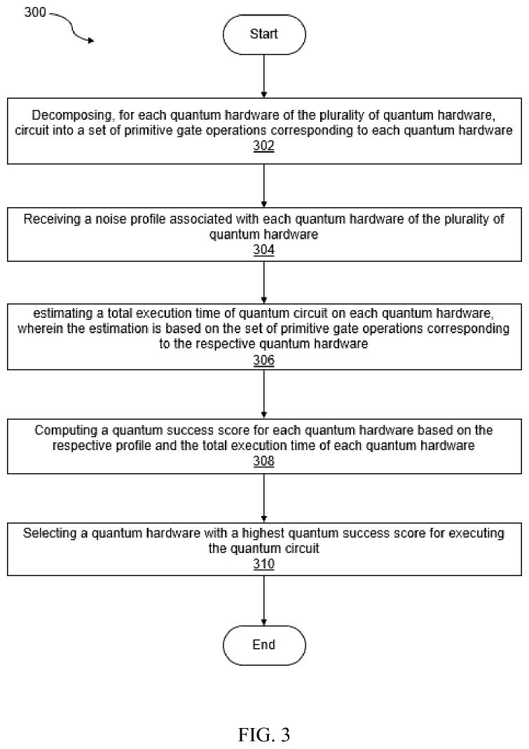

FIG. 3 is a flowchart of a method for a method for selecting a quantum hardware from a plurality of quantum hardware for executing a quantum circuit in accordance with an exemplary implementation of the disclosure. Referring to FIG. 3, there is shown a flowchart of a method 300 which includes steps 302, 304, 306, 308 and 310.

At 302, the method 300 includes decomposing, for each quantum hardware of the plurality of quantum hardware, circuit into a set of primitive gate operations corresponding to each quantum hardware.

At 304, the method 300 includes receiving a noise profile associated with each quantum hardware of the plurality of quantum hardware. A noise profile of a quantum hardware includes one of a qubit quality, qubit properties, a hardware specific relaxation time, a coherence time, error rates corresponding to the primitive gate operations. Accordingly, the invention takes into consideration a noise profile of a quantum hardware for evaluating the suitability of the quantum hardware for a given quantum circuit.

At 306, the method 300 includes estimating a total execution time of quantum circuit on each quantum hardware, wherein the estimation is based on the set of primitive gate operations corresponding to the respective quantum hardware. The total execution time of quantum circuit also depends on the parameters of the quantum circuit such as, but not limited a gate count, gate types, a circuit depth, and other characteristics relevant to quantum computation.

At 308, the method 300 includes computing a quantum success score for each quantum hardware based on the respective noise profile and the total execution time of each quantum hardware.

At 310, the method 300 includes initiating selecting a quantum hardware with a highest quantum success score for executing the quantum circuit.

The method and system offer an advantageous approach by providing a holistic evaluation, significantly impacting quantum hardware selection for enhanced computational accuracy. This method and system facilitate a comprehensive evaluation of quantum hardware, through the simultaneous consideration of noise profiles of quantum hardware, quantum circuit properties, and other pertinent factors, it provides a framework for optimized hardware selection, leading to improved accuracy in quantum computations.

The method and system are advantageous in a manner that it optimizes quantum hardware selection process surpassing conventional methods. The method and system errors introduced by Amplitude Damping, Phase Damping, and errors due to noisy gate operations measurements while evaluating their suitability for a given quantum circuit.

The method and system provide an effective mechanism of selecting quantum hardware surpassing standardized benchmarks by considering various properties of a given quantum circuit. By recognizing and accommodating the diverse requisites and limitations across different quantum circuits, the method and system ensures a more refined selection of quantum hardware, optimizing performance for the quantum circuit.

The method and system provide an economical approach in selecting the most suitable quantum hardware without using any additional quantum resources.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus/devices adapted to carry out the methods described herein may be suited. A combination of hardware and software may be a general-purpose computer system with a computer program that, when loaded and executed on the computer system, may control the computer system such that it carries out the methods described herein. The present disclosure may be realized in hardware that comprises a portion of an integrated circuit that also performs other functions. The present disclosure may also be realized as a firmware which form part of the media rendering device.

The present disclosure may also be embedded in a computer program product, which includes all the features that enable the implementation of the methods described herein, and which when loaded and/or executed on a computer system may be configured to carry out these methods. Computer program, in the present context, means any expression, in any language, code or notation, of a set of instructions intended to cause a system with information processing capability to perform a particular function either directly, or after either or both of the following: a) conversion to another language, code or notation; b) reproduction in a different material form.

While the present disclosure is described with reference to certain implementations, it will be understood by those skilled in the art that various changes may be made, and equivalents may be substituted without departure from the scope of the present disclosure. In addition, many modifications may be made to adapt a particular situation or material to the teachings of the present disclosure without departure from its scope.

What is claimed is:

1. A system for selecting a quantum hardware from a plurality of quantum hardware for executing a quantum circuit, the system comprising:
a decomposing model for decomposing the quantum circuit into a set of primitive gate operations corresponding to each quantum hardware;
a parameter fetching module for receiving a noise profile corresponding to each quantum hardware of the plurality of quantum hardware;
a time estimator module for estimating a total execution time of the quantum circuit on each quantum hardware, wherein a total exaction time on a quantum hardware is estimated based on a set of primitive gate operations corresponding to the quantum hardware;
a success score computing module for computing a quantum success score of each quantum hardware based on the corresponding noise profile and the total execution time of each quantum hardware; and
a hardware selection module for selecting a quantum hardware with a highest quantum success score for executing the quantum circuit.

2. The system as claimed in claim 1, wherein a noise profile of a quantum hardware comprises one of a qubit quality, qubit properties, a hardware specific relaxation time, a coherence time, error rates corresponding to the primitive gate operations.

3. The system as claimed in claim 2, wherein the parameters of the quantum circuit comprise one of the properties of the quantum circuit, a gate count, gate types, a circuit depth, and other characteristics relevant to quantum computation.

4. The system as claimed in claim 2, wherein the success score computing module takes into consideration error probability of the quantum circuit due to amplitude damping, phase damping, errors due to noisy gate errors, and errors due to state preparation and measurement for computing the success score.

5. A method for selecting a quantum hardware from a plurality of quantum hardware for executing a quantum circuit, the method comprising:
decomposing, for each quantum hardware of the plurality of quantum hardware, the quantum circuit into a set of primitive gate operations corresponding to each quantum hardware;
receiving a noise profile associated with each quantum hardware of the plurality of quantum hardware;
estimating a total execution time of the quantum circuit on each quantum hardware, wherein the estimation is based on the set of primitive gate operations corresponding to the respective quantum hardware;
computing a quantum success score for each quantum hardware based on the respective noise profile and the total execution time of each quantum hardware; and
selecting a quantum hardware with a highest quantum success score for executing the quantum circuit.

6. The method as claimed in claim 5, wherein a noise profile of a quantum hardware comprises one of a qubit quality, qubit properties, a hardware specific relaxation time, a coherence time, and error rates associated with the primitive gate operations.

7. The method as claimed in claim 5, wherein the parameters of the quantum circuit comprise one of the properties of the quantum circuit, a gate count, gate types, a circuit depth, and other characteristics relevant to quantum computation.

8. The method as claimed in claim 5, wherein the computing a quantum success score of each quantum hardware depends on error probability of the quantum circuit due to amplitude damping, phase damping, errors due to noisy gate errors, and errors due to state preparation and measurement.
